(19) United States
(12) Patent Application Publication
(10) Pub. No.: US 2010/0212214 A1
(43) Pub. Date: Aug. 26, 2010

(54) CANDLE COMPOSITION

(75) Inventors: Boneng WU, Toronto (CA); Dennis Kwok Wai YUNG, Mississauga (CA)

Correspondence Address: WALKER & JOCKE, L.P.A., 231 SOUTH BROADWAY STREET, MEDINA, OH, 44256, US

(73) Assignee: PREMIER CANDLE CORP., Mississauga (CA)

(21) Appl. No.: 12/711,350

(22) Filed: Feb. 24, 2010

(30) Foreign Application Priority Data
Feb. 25, 2009 (CA) 2655367

(51) Int. Cl. C11C 5/00; B29C 39/00

(52) U.S. Cl. 44/275; 264/299

(57) ABSTRACT

A candle composition having fatty alcohol and vegetable-based wax. A candle composition having fatty alcohol and vegetable-based wax, and wherein the fatty alcohol comprises 0.5% to 99.5% by mass. A process for making a candle composition is also provided, the process comprising mixing together a fatty alcohol and a vegetable-based wax, heating the mixture to a temperature of 70-80° C., pouring into a container or mould, and cooling the mixture.

### FIELD OF THE INVENTION

This invention relates to candle compositions. In particular, this invention relates to candle compositions comprising fatty alcohol and a process for making a candle compositions comprising fatty alcohol.

### BACKGROUND OF THE INVENTION

Candles have been used for centuries as a source of light and for their aesthetic appeal. Paraffin wax has been traditionally used in making candles, which conventionally comprises 80 to 100% paraffin wax. Paraffin wax is also a petroleum by-product and is known to produce toxins, black soot and carcinogens. While beeswax may also be used as candle wax, some users may not find beeswax desirable due to its poor burn performance. Moreover, although beeswax is considered a renewable wax, it is very expensive and therefore not profitable for large-scale candle applications. It would therefore be advantageous to eliminate or reduce the paraffin wax and beeswax used in candles in favour of alternative substances, such vegetable derived materials and ingredients.

There is currently a need for a renewable candle wax composition that is natural and environmental-friendly. In particular, it would be advantageous to have a candle wax composition that uses renewable ingredients and therefore is also biodegradable.

Some manufacturers in the candle industry have started using triglycerides and fatty acids as the main ingredients of wax for candle production. However there are several disadvantages of such renewable candle compositions, such as: undesirable blooming/frosting due to crystallization of triglycerides and fatty acids during the phase changing from liquid to solid; pits, bubbles and/or holes in the candle composition; and poor burn performance and low wax consumption.

It is therefore advantageous to have an improved candle composition that is more environmental-friendly than previous compositions, and overcomes disadvantages associated with previous compositions.

### DETAILED DESCRIPTION OF THE PREFERRED EMBODIMENTS

In the embodiments described below, there is provided a renewable candle composition that may be considered eco-friendly.

According to one embodiment, there is a provided a candle composition comprising fatty alcohol. According to another embodiment, there is provided a candle composition comprising fatty alcohol and vegetable-based wax.

Fatty alcohols are natural ingredients from plant-based or animal-based materials and thus are used as an ingredient for all-natural, renewable wax candles.

Examples of fatty alcohol include plant-based fatty alcohol, such as jojoba alcohol, which is a mixture of free fatty alcohols of between 16 and 24 carbon atoms (derived from jojoba oil), and animal-based fatty alcohol. Fatty alcohols can also be made from fatty acid by the process of catalytic hydrogenation to meet the need for large-scale industrial applications. Cetyl alcohol (palmitic alcohol) and stearyl alcohol are the most widely-used fatty alcohols due to the industrial abundance of palmitic acid (from palm oil) and stearic acid (from soy oil or animal fat). Cetyl alcohol (49° C. melting point, 180° C. boiling point, and 160° C. open cup flash point) and stearyl alcohol (61° C. melting point, 210° C. boiling point and 200° C. open cup flash point) are preferred fatty alcohols for the purposes of the present embodiments. However, any of the following fatty alcohols and mixtures of the following fatty alcohols may also be used:

| Common | | | Molecular |
|---|---|---|---|
| name | IUPAC name | | formula |
| Capryl | 1-octanol | C-8 fatty | CH₃(CH₂)₇OH |
| alcohol | | alcohol | |
| Capric | 1-decanol | C-10 fatty | CH₃(CH₂)₉OH |
| alcohol | | alcohol | |
| Lauryl | 1-dodecanol | C-12 fatty | CH₃(CH₂)₁₁OH |
| alcohol | | alcohol | |
| Myristic | 1-tetradecanol | C-14 fatty | CH₃(CH₂)₁₃OH |
| alcohol | | alcohol | |
| Cetyl | 1-hexadecanol | C-16 fatty | CH₃(CH₂)₁₅OH |
| alcohol | | alcohol | |
| Stearyl | 1-octadecanol | C-18 fatty | CH₃(CH₂)₁₇OH |
| alcohol | | alcohol | |
| Arachidyl | 1-eicosanol | C-20 fatty | CH₃(CH₂)₁₉OH |
| alcohol | | alcohol | |
| Behenyl | 1-docosanol | C-22 fatty | CH₃(CH₂)₂₁OH |
| alcohol | | alcohol | |
| Lignoceryl | 1-tetracosanol | C-24 fatty | CH₃(CH₂)₂₃OH |
| alcohol | | alcohol | |
| Ceryl | 1-hexacosanol | C-26 fatty | CH₃(CH₂)₂₅OH |
| alcohol | | alcohol | |
| Montanyl | 1-octacosanol | C-28 fatty | CH₃(CH₂)₂₇OH |
| alcohol | | alcohol | |
| Myricyl | 1-triacontanol | C-30 fatty | CH₃(CH₂)₂₉OH |
| alcohol | | alcohol | |
| Geddyl | 1-tetratriacontanol | C-34 fatty | CH₃(CH₂)₃₃OH |
| alcohol | | alcohol | |

Different kinds of fatty alcohols may be mixed to obtain an amorphous, semi-transparent candle composition with a strong structure. A single fatty alcohol tends to crystallize more than a mixture of two or more fatty alcohols, and therefore mixtures of fatty alcohols are preferred to form an amorphous substance with a stronger structure.

Candle compositions comprised of triglycerides and fatty acid (and without fatty alcohol) tend to crystallize very easily. This crystallization is primarily due to the similarity of molecule structure and polarity of the triglyceride and fatty acid. Crystallization causes pits, bubbles and/or holes in the candle composition during production processing and results in a significantly longer and slower cooling process (to avoid blooming and cracking) in production. This results in the following problems during the production process: high labour cost and high energy consumption due to the longer and slower production; loss of fragrance during the long, slow and hot production process; a high scrap rate; a low production rate; and changes in colour and/or oxidation of the wax due to the high temperatures during the longer production process. In addition, the crystallization of the fatty acid and triglycerides during the congealing step in the production process causes tension build-up within the candle. As a result, the candle becomes brittle and unstable when exposed to low temperature.

The crystallization that occurs in the triglyceride and fatty acid candle also causes significant bubbling when the candle is burned. The bubbling causes lots of cheese-like holes on the candle surface and thereby results in a candle having an unfavourable appearance. In addition, the triglyceride and fatty acid renewable candles usually have a poor burn performance and low wax consumption rate due to the higher boiling point and flash point of the triglyceride and fatty acid. Vegetable waxes blended with paraffin can improve the overall burn quality since paraffin contains alkane portions of low flash point (about 100° C. lower than the flash point of triglyceride-based fuel), however the introduction of paraffin is contrary to the concept of a renewable, all-natural candle. Alternatively, triglycerides-based fuel can be chemically modified to improve burn performance by the process of transesterification, which results in a biodiesel product. However chemical modification consumes energy and produces wastes and thus is also contrary to the concept of a renewable, eco-friendly product.

Fatty alcohols are amphiphatic in nature (i.e. possess hydrophilic and hydrophobic properties) and thus function as non-ionic surfactants and thereby are suitable emulsifiers in lipid-based environments, such as a vegetable wax.

Fatty alcohol inhibits the crystallization of triglyceride and fatty acid in a candle composition and thereby prevents the sharp phase change (ie. from liquid to solid) during the congealing process of the wax composition and therefore results in a lower likelihood of crystallization, a lower likelihood of tension build-up within the wax and therefore less cracking. As a result, there is less blooming and frosting during the candle manufacturing process, and less bubbling during and after the burn. The production process is faster and there is a lower scrap rate and less re-work, resulting in a better quality candle, a higher production rate and a lower energy consumption process.

Fatty alcohols also lower the viscosity of liquid wax. Low viscosity of liquid wax results in an improvement of the fuel supplying to sustain the burn. Therefore a candle wax component containing fatty alcohol burns well and is more “clean” with less soot. In addition, smaller wick sizes are required.

The suitable boiling points (cetyl alcohol: 180° C.; stearyl alcohol: 210° C.) of the fatty alcohols not only contribute to a better burn of the combination but also help to prevent the liquid wax pool from being overheated by the flame. For example, in the cetyl-stearyl alcohol blending renewable wax, when the temperature at the root of the flame reaches 180-210° C., the cetyl alcohol and stearyl alcohol components evaporate rapidly and therefore absorb a large amount of heat and therefore avoid further increased temperature. The temperature at the root of the flame will be maintained within 180-210° C. This prevents the renewable wax from becoming a yellowish-brown colour after several cycles of burn. On the other hand, the triglyceride based components (blending of triglycerides and fatty alcohols) control the over evaporating of fatty alcohols components in the mixture and therefore avoid the hazard of entire candle body catching fire.

The amphipathic nature of fatty alcohol can also help fragrances to disperse into the wax mixture. Consequently there will be less fragrance bleeding/leaking when fatty alcohols are included in the wax composition. For example, cetyl-stearyl blending alcohol can solidify high amounts of fragrance oil, thereby providing a better quality candle composition.

According to another embodiment, a candle composition is provided having fatty alcohol and vegetable-based wax, wherein the fatty alcohol comprises 0.5% to 99.5% by mass of the total composition. The vegetable-based wax may include triglycerides, mono-glycerides, di-glycerides, fatty acids, non-hydrogenated lipids and any mixtures thereof. The triglycerides can be solid form triglycerides and/or semi-solid form triglycerides.

Examples of suitable triglycerides include, without limitation, fully hydrogenated vegetable oil, partially hydrogenated vegetable oil, non-hydrogenated vegetable oil, and animal fat/lipid. Examples of mono-triglycerides include, without limitation, glyceryl moonoleate, glyceryl monolaurate, and glyceryl monostearate. Examples of di-glycerdies include, without limitation, glyceryl dioleate, glyceryl dilaurate and glyceryl distearate.

The fatty acids can be lauric acid, myristic acid, palmitic acid, stearic acid, oleic acid, linoleic acid or any mixtures thereof. A person skilled in the art would understand the types of vegetable-based waxes and fatty acids that could be used in the present embodiments.

According to another embodiment, a candle composition is provided having 55-100% by mass fatty alcohol and the remainder non-hydrogenated vegetable lipid. For the purposes of the present embodiments, acceptable non-hydrogenated vegetable lipids may include, without limitation, soybean oil, sunflower oil, safflower oil, grape seed oil, corn oil, palm oil, olive oil, cotton seed oil, canola oil, coconut oil, jojoba oil, and any mixture thereof.

According to a further embodiment, there is provided a process for making a candle composition. The process includes combining a fatty alcohol and a vegetable-based wax, and heating the mixture to a temperature of 70-80° C. The mixture is stirred until completed melting and the melting temperature is brought to 70-80° C. Fragrances and antioxidants may be added to the mixture, and the liquid wax temperature is maintained for about 10 minutes within a range of 60-85° C., preferably within 70-80° C. The mixture is then cooled and poured into a candle container.

The following are examples of a preferred embodiment of the present invention, without limiting its scope as defined by the claims.

### EXAMPLE 1

This example is a candle composition formed from fatty alcohol, hydrogenated coconut oil and a plant-based wax. The wax base ingredients are:

Palm wax 6910: 45%

Cetyl alcohol: 15%

Stearyl alcohol: 15%

(92F) hydrogenated coconut oil: 25%

Sample detail: Fragrance: 5% crisp cotton; Wick: CDN10 with sustainer; Jar candle: 9 oz

Batching Process:

Follow the formula weight and place all ingredients into the batching tank. Heat and melt the mixture and stir for about 10 minutes while trying to keep the wax temperature within 70-80° C. Then put the fragrance and stir the liquid wax mixture for another 10 minutes. Maintain the liquid wax temperature within 60-85° C., preferably within 70-80° C.

Prepare the wick and jar for the candles. Preheat the jar before pouring the mixture into the jar. Jar temperature should reach 45° C., preferably 50° C.+/−5° C.), to avoid wick wax from melting down. Then pour a requisite amount of liquid wax into to the jar. 3-5 minutes after pouring apply fan from bottom or sides of the jar to cool down the candle. In addition, 90-120 minutes after first pouring, heat the surface of the candle and apply second pour on top, if desired.

A candle composition having this formula can be hot-packed without bubbling and pitting trouble thereafter. The appearance, burn performance and wax consumption of this candle is excellent, and the wax pool does not turn yellow after many cycles of burn.

### EXAMPLE 2

This example is a candle composition formed from fatty alcohols and a soy wax. The wax base ingredients are:

C-3 soy wax: 80%

Cetyl alcohol: 10%

Stearyl alcohol: 10%

Sample detail: Fragrance: 5% Crisp Cotton B; Wick: CDN10 with sustainer; Jar candle: 9 oz

Batching process:

Follow the formula weight and place all ingredients into the batching tank. Heat and melt the mixture and stir for about 10 minutes, trying to keep the wax temperature within 70-80° C. Then add the fragrance and stir the liquid wax mixture for another 10 minutes. Maintain the liquid wax temperature within 60-85° C., preferably within 70-80° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring, apply fan from bottom or sides of the jar to cool down the candle. 90-120 minutes after first pouring, heat the surface of the candle to make it flat, and if desired, apply second pour on top.

This candle composition congeals much faster with less blooming, wrinkling and cracking. In particular, it can be hot-packed without further causing bubbling and pitting troubles. The appearance, burn performance and wax composition is good. Anti-oxidants (as an example, 0.05—0.1% of Irganox 1076 and/or Irganox PS802 from CIBA) may be added to prevent the wax pool from becoming oxidized after many burns.

### EXAMPLE 3

This example is also a candle composition formed from fatty alcohol and a soy wax. The wax base ingredients are:

C-3 soy wax: 70%

Cetyl alcohol: 15%

Stearyl alcohol: 15%

Sample detail: Fragrance: 5% Crisp Cotton; Wick: CDN8 with sustainer; Jar candle: 9 oz

Batching Process:

Follow the formula weight and place all ingredients into the batching tank. Heat and melt the mixture and stir for about 10 minutes, while trying to keep the wax temperature within 70-80° C. Then put fragrance and stir the liquid wax mixture for another 10 minutes, while maintaining the liquid wax temperature within 70-80° C.

Prepare the wick and jar for the candles. Preheat the jar before pouring the mixture into the jar. Jar temperature should reach 45° C. (better 50° C.+/−5° C.). Then pour the requisition amount of liquid wax into the jar. 3-5 minutes after pouring apply fan from bottom or sides of the jar to cool down the candle. 90-120 minutes after first pouring, heat the surface of the candle to make it flat, and if desired, apply second pour on top.

This is the revised version of Example 2 with more cetyl alcohol, stearyl alcohol content in order to further reduce the bubbles during candle burn. The candle composition congeals much faster with less blooming, wrinkling and cracking when fatty alcohol is added to the C-3 blend. The burning performance is much better for these compositions than that of 100% C-3 candle. If using 100% C-3 blend in a 9 oz jar, the wick needs to be CDN20-22 and there are lots of bubbles during the candle burn. However if 20-30% of cetyl/stearyl alcohol is added, the wick will be CDN8-10 and there is significantly less, if not zero, bubbling during burn.

### EXAMPLE 4

This example is a candle composition formed from fatty alcohol, a plant-based wax and a mono-glyceride. The wax base ingredients are:

Palm wax 6910: 70%

Cetyl alcohol: 10%

Stearyl alcohol: 10%

Glyceryl monooleate: 10%

Sample detail: Fragrance: 5% Crisp Cotton; Wick: CDN14 with sustainer for 9 oz jar candle

Batching Process:

Follow the formula weight and place all ingredients into the batching tank. Heat and melt the mixture and stir for about 10 minutes, while keeping the wax temperature within 70-80° C. Then put fragrance and stir the liquid wax mixture for another 10 minutes while maintaining the liquid wax temperature within 70-80° C.

Prepare the wick and jar for the candles. Preheat the jar before pouring the requisite amount of mixture into the jar. The jar temperature should reach 45° C., to preferably 50° C.+/−5° C. Then pour the requisite amount of liquid wax into the jar. 3-5 minutes after pouring apply fan from bottom or sides of the jar to cool down the candle. 90-120 minutes after first pouring, heat the surface of the candle to make it flat, and if desired, apply second pour on top.

Candle with this formula looks nice with very good adhesion of wax on the wall of the jar even when the candle is placed in a 10° C. environment for a long period of time. This formula is for the customer which request good adhesion effect.

### EXAMPLE 5

This example is another candle composition formed from fatty alcohol, a plant-based wax and a mono-glyceride. The wax base ingredients are:

Palm wax 6910: 55%

Cetyl alcohol: 15%

Stearyl alcohol: 15%

Glyceryl monooleate: 15%

Sample detail: Fragrance: 5% Crisp Cotton; Wick: CDN12 with sustainer for 9 oz jar candle

Batching Process:

Follow the formula weight and place all ingredients into the batching tank. Heat and melt the mixture and stir for about 10 minutes, while keeping the wax temperature within 70-80° C. Then put the fragrance and stir the liquid wax mixture for another 10 minutes, while maintaining the liquid wax temperature within 70-80° C.

Prepare the wick and jar for the candles. Preheat the jar before pouring the mixture in to the jar. Jar temperature should reach 45° C., preferably 50° C.+/−5° C. Then pour the requisite amount of liquid wax into the jar. 3-5 minutes after pouring apply fan from bottom or sides of the jar to cool down the candle. 90-120 minutes after first pouring, heat the surface of the candle to make it flat, and if desired, apply second pour on top.

A candle with this composition looks nice and the wax can be easily pulled off from the glass wall of the jar. This formulation is preferred for candles having a soft and smooth surface.

### EXAMPLE 6

This example is a candle composition formed from fatty alcohol and hydrogenated coconut oil. The wax base ingredients are:

Hydrogenated coconut oil (92F): 40%

Cetyl alcohol: 18%

Stearyl alcohol: 42%

Sample detail: Fragrance: 5% Crisp Cotton; Wick: CDN12 with sustainer; Jar candle: 9 oz

Batching Process:

Follow the formula weight and place all ingredients into the batching tank. Heat and melt the mixture and stir for about 10 minutes, while keeping the wax temperature within 70-75° C. Then add the fragrance and stir the liquid wax mixture for another 10 minutes, while maintaining the liquid wax temperature within 70-75° C.

Prepare the wick and jar for the candles. Preheat the jar before pour the mixture in to the jar. Jar temperature should reach 40° C., preferably between 40-45° C. Then pour the requisite amount of liquid wax into the jar. 3-5 minutes after pouring apply fan from bottom or sides of the jar to cool down the candle. 40-60 minutes after first pouring, heat the surface of the candle to make it flat, and if desired, apply second pour on top.

Candle compositions with this formulation have a crystallized effect and can be hot-packed without bubbling and pitting troubles thereafter. Both the burn performance and wax consumption are very good.

### EXAMPLE 7

This example is another candle composition formed from fatty alcohol and hydrogenated coconut oil. The wax base ingredients are:

Hydrogenated coconut oil (92F): 40%

Stearyl alcohol: 60%

Sample detail: Fragrance: 5% Crisp Cotton; Wick: CDN12 with sustainer; Jar candle: 9 oz.

Batching Process:

Follow the formula weight and place all the ingredients into the batching tank. Heat and melt the mixture and stir for about 10 minutes, while keeping the wax temperature within 70-75° C. Then add the fragrance and stir the liquid wax mixture for another 10 minutes, while maintaining the liquid wax temperature within 70-75° C.

Prepare the wick and jar for the candles. Jar preheat is not necessary if a white wash look result is desired. Jar temperature should be 10-40° C. Then pour the requisite amount of liquid wax into the jar. 3-5 minutes after pouring, apply fan from bottom or sides of the jar to cool down the candle. 40-60 minutes after first pouring, heat the surface of the candle to make it flat, and if desired, apply second pour on top.

Candles with this formula have a crystallized effect and can be hot-packed without bubbling and pitting troubles thereafter. Both the burn performance and wax consumption are very good.

### EXAMPLE 8

This example is a candle composition formed from fatty alcohol and a plant-based fatty acid, for the moulded pillar and votive candle. The wax base ingredients are:

Palm fatty acid 3999: 55%

Cetyl alcohol: 15%

Stearyl alcohol: 30%

Sample detail: Fragrance: 5% Tobacco vanilla; Pillar candle: 3×4 inches, 3×6 inches, 4×6 inches and 6×4 inches.

Batching Process:

Follow the formula weight and place all ingredients into the batching tank. Heat and melt the mixture and stir for about 10 minutes, while keeping the wax temperature within 70-80° C. Then add the fragrance and stir the liquid wax mixture for another 10 minutes, while maintaining the liquid wax temperature within 70-80° C.

Preheat the moulds, preferably to 50-55° C., before pouring the mixture into the mould. Then pour the requisite amount of liquid wax into the mould. 3-5 minutes after pouring apply fan from bottom or sides of the mould to cool down the candle. 90-120 minutes after first pouring, apply second pour on top, if desired. A second pour is generally needed for pillar candles.

### EXAMPLE 9

This example is a candle composition formed from fatty alcohol, a plant-based wax and non-hydrogenated vegetable oil. The wax base ingredients are:

Palm wax 6910: 40%

Cetyl alcohol: 15%

Stearyl alcohol: 15%

Corn oil: 30%

Sample detail: Fragrance: 5% Sheer White Cotton; Wick: CDN14 with sustainer for 9 oz jar single wick candle; Wick: CDN3 with sustainer for 10 oz jar 3-wick candle.

Batching Process:

Follow the formula weight and place palm wax 6910, cetyl alcohol and stearyl alcohol into the batching tank. Heat and melt the mixture and stir for about 10 minutes, while keeping the wax temperature up to 80° C. Then put corn oil into batching tank and mix well. Then add the fragrance and stir the liquid wax mixture for another 10 minutes, while maintaining the liquid wax temperature within 70-75° C.

Prepare the wick and jar for the candles. Preheat the jar before pouring mixture into the jar. Jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candle with this formula can be hot-packed without bubbling and pitting troubles thereafter. The appearance is nice and the burn is good. The wax does not turn yellow after several burn cycles. The wax consumption is good.

### EXAMPLE 10

This example is a candle composition formed from fatty alcohol, a plant-based wax and non-hydrogenated vegetable oil. The wax base ingredients are:

Palm wax 6910: 40%

Cetyl alcohol: 15%

Stearyl alcohol: 15%

Cold pressed extra virgin olive oil: 30%

Sample detail: Fragrance: 5% Sheer White Cotton; Wick: CDN14 with sustainer for 9 oz jar single wick candle; Wick: CDN3 with sustainer for 10 oz jar 3-wick candle.

Batching Process:

Follow the formula weight and place palm wax 6910, cetyl alcohol and stearyl alcohol into the batching tank. Heat and melt the mixture and stir for about 10 minutes, while keeping the wax temperature at about 80° C. Then add the olive oil into the batching tank and mix well. Then add the fragrance and stir the liquid wax mixture for another 10 minutes, while maintaining the liquid wax temperature within 70-75° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candle with this formula can be hot-packed without bubbling and pitting troubles thereafter. The appearance is nice and the burn is good. The wax does not turn yellow after several burn cycles and the wax consumption is good.

### EXAMPLE 11

This example is a candle composition formed from fatty alcohol, a plant-based wax and non-hydrogenated vegetable oil. The wax base ingredients are:

Palm wax 6910: 40%

Cetyl alcohol: 15%

Stearyl alcohol: 15%

Grape seed oil: 30%

Sample detail: Fragrance: 5% Sheer White Cotton; Wick: CDN12 with sustainer for 9 oz jar single wick candle; Wick: CDN3 with sustainer for 10 oz jar 3-wick candle.

Batching Process:

Follow the formula weight and place palm wax 6910, cetyl alcohol and stearyl alcohol into the batching tank. Heat and melt the mixture and stir for about 10 minutes, while keeping the wax temperature at about 80° C. Then add the grapeseed oil into the batching tank and mix well. Then add the fragrance and stir the liquid wax mixture for another 10 minutes, while maintaining the liquid wax temperature within 70-75° C.

Prepare the wick and jar for the candles. Preheat the jar before pouring the mixture into the jar. The Jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candles with this formula can be hot-packed without bubbling and pitting troubles thereafter. The appearance is nice and the burn is good. The wax does not turn yellow after several burn cycles, and the wax consumption is good.

### EXAMPLE 12

This example is a candle composition formed from fatty alcohol non-hydrogenated sunflower oil and a plant-based wax. The wax base ingredients are:

Palm wax 6910: 40%

Stearyl alcohol: 20%

Sunflower oil (mid-oleic): 40%

Sample detail: Fragrance: 5% Sheer White Cotton; Wick: CDN12 with sustainer for 9 oz jar single wick candle; Wick: CDN3 with sustainer for 10 oz jar 3-wick candle.

Batching Process:

Follow the formula weight and place palm wax 6910 and stearyl alcohol into the batching tank. Heat and melt the mixture and stir for about 10 minutes, while keeping the wax temperature at about 80° C. Then add the sunflower oil into batching tank and mix well. Then add the fragrance and stir the liquid wax mixture for another 10 minutes, while maintaining the liquid wax temperature within 70-75° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candles with this formula can be hot-packed without bubbling and pitting troubles thereafter. The appearance is nice and the burn is good. The wax does not turn yellow after several burn cycles, and the wax consumption is good.

### EXAMPLE 13

This example is a candle composition formed from fatty alcohol, partially to hydrogenated soybean oil and a plant-based wax. The wax base ingredients are:

Partially hydrogenated soybean oil (as an example, S-560 from Cargill): 60%

Palm wax 6910: 10%

Stearyl alcohol: 15%

Cetyl alcohol: 15%

Sample detail: Fragrance: 5% Sheer White Cotton; Wick: CDN10 with sustainer for 9 oz jar single wick candle.

Batching Process:

Follow the formula weight and place all ingredients into the batching tank. Heat and melt the mixture and stir for about 10 minutes, while keeping the wax temperature within 70-80° C. Then add the fragrance and stir the liquid wax mixture for another 10 minutes, while maintaining the liquid wax temperature within 70-80° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candles with this formula have the same texture of Vaseline/Petrolatum jelly wax. The look of the candle composition is greasy and semi-transparent. The burn is good, and the wax does not turn yellowish after several burn cycles.

### EXAMPLE 14

This example is another candle composition formed from fatty alcohol, partially hydrogenated soybean oil and a plant-based wax. The ingredients are:

Partially hydrogenated soybean oil (as an example, S-560 from Cargill): 55%

Palm wax 6910: 15%

Stearyl alcohol: 15%

Cetyl alcohol: 15%

Sample detail: Fragrance: 5% Sheer White Cotton; Wick: CDN8 with sustainer for 9 oz jar single wick candle.

Batching Process:

Follow the formula weight and place all ingredients into the batching tank. Heat and melt the mixture and stir for about 10 minutes, keeping the wax temperature within 70-80° C. Then add the fragrance and stir the liquid wax mixture for another 10 minutes, maintaining the liquid wax temperature within 70-80° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring apply fan from bottom or sides of the jar to cool down the candle. 60-120 minutes after first pouring, heat the surface of the candle to make it flat, and if desired, apply second pour on top.

Candle with this formula has the same texture of Vaseline/Petrolatum jelly wax. The look of the candle composition is greasy and semi-transparent. The burn is good, and the wax does not turn yellowish after several burn cycles.

### EXAMPLE 15

This example is a candle composition formed from fatty alcohol, non-hydrogenated soybean oil and a plant-based wax. The wax base ingredients are:

Palm wax 6910: 40%

Stearyl alcohol: 15%

Cetyl alcohol: 15%

RBD (refined, bleached and deodorized) soybean oil: 30%

Sample detail: Fragrance: 5% Sheer White Cotton; Wick: CDN12 with sustainer for 9 oz jar single wick candle.

Batching Process:

Follow the formula weight, and place palm wax 6910, cetyl alcohol and stearyl alcohol into the batching tank. Heat and melt the mixture and stir for about 10 minutes, while keeping the wax temperature up to 80° C. Then pour RBD soybean oil into the batching tank and mix the liquid well. Then add the fragrance and stir the liquid wax mixture for another 10 minutes, while maintaining the liquid wax temperature within 65-70° C.

Prepare the wick and jar for the candles. Preheat the jar before pouring the mixture into the jar. The jar temperature should reach 45° C., preferably 50° C.+/−5° C. Then pour the requisite amount of liquid wax into the jar. 3-5 minutes after pouring apply fan from bottom or sides of the jar to cool down the candle. 90-120 minutes after first pouring, heat the surface of the candle and apply second pour on top.

In addition, when candle composition contains non-hydrogenated soybean oil, a certain amount (for example, 0.1%-0.2% by weight of Irganox 1076 and/or Irganox PS802 from CIBA) of antioxidant should be added to prevent wax from being oxidized and turning yellowish-brown during burn.

Candles with this formula can be hot-packed without bubbling and pitting troubles thereafter. The appearance is nice, and the burn and wax consumption are good.

### EXAMPLE 16

This example is a candle composition formed from fatty alcohol, a plant-based wax and lauric acid. The wax base ingredients are:

Palm wax 6910: 60%

Cetyl alcohol: 15%

Stearyl alcohol: 15%

Lauric acid: 10%

Sample detail: Fragrance: 5% Crisp Cotton; Wick: CDN12 with sustainer for 9 oz jar candle (and the same size of pillar).

Batching Process:

Follow the formula weight and place all ingredients into the batching tank. Heat and melt the mixture and stir for about 10 minutes, while keeping the wax temperature within 70-80° C. Then put the fragrance and stir the liquid wax mixture for another 10 minutes, while maintaining the liquid wax temperature within 60-75° C.

Prepare the wick and jar for the candles. Preheat the jar before pouring the mixture in to the jar. Jar temperature should reach 45° C., preferably 50° C.+/−5° C. Then pour the requisite amount of liquid wax into the jar. 3-5 minutes after pouring apply fan from bottom or sides of the jar to cool down the candle. 90-120 minutes after first pouring, heat the surface of the candle to make it flat, and if desired, apply second pour on top.

A candle wax with this composition is hard and the wax can be easily pulled off from the glass wall of the container. But candle wax is strong enough to avoid cracking during production processing. This formulation is also preferred for re-fill candle set (candle set contains one container candle and several separated re-fill pillars in order to reduce the consumption of container).

The candle composition of the preferred embodiments has the following advantages: 1) wax base is 100% renewable and 100% biodegradeable; 2) low energy consumption and more eco-friendly process (with faster production speed, low scrap rate and less re-work); 3) candle with this kind of wax can be hot packed with less appearance defects of bubbling, pitting, frosting and cracking; 4) high fragrance loading capacity (up to 50%); 5) burn performance is very good—smaller wick with less soot—thus also more environmental friendly; 6) good wax consumption rate; 7) less chance to turn yellowish brown while candle burned; 8) nice delicate appearance that can be presented as high-end candle products; 9) raw materials are sustainable and easy to obtain (and there is no reliance on the petroleum market); and 10) quality control of both ingredients and candle are easily conducted when compared with paraffin based wax (as example, Gas Chromatography for fatty alcohol analysis; Saponification Value and Iodine Value for other vegetable ingredients analysis), thus guarantee both quality and safety of the candle composition.

Various embodiments of the present invention having been thus described in details of example, it will be apparent to those skilled in the art that variations and modifications may be made without departing from the invention. The invention includes all such variations and modifications as fall within the scope of the appended claims.

What is claimed is:

1. A candle composition comprising fatty alcohol.

2. A candle composition comprising fatty alcohol and vegetable-based wax.

3. A candle composition of claim 2, wherein the fatty alcohol comprises 0.5% to 99.5% by mass.

4. The candle composition of claim 2, wherein the fatty alcohol is selected from the group consisting of cetyl alcohol, stearyl alcohol and any combination thereof.

5. The candle composition of claim 2, wherein the fatty alcohol is selected from arachidyl alcohol, benhenyl alcohol, lignoceryl alcohol and any combination thereof.

6. The candle composition of claim 2, wherein the vegetable-based wax is selected from the group consisting of triglycerides, mono-glycerides, di-glycerides, fatty acids, and combinations thereof.

7. The candle composition of claim 6, wherein the triglyceride is solid form triglyceride and/or semi-solid form triglyceride.

8. The candle composition of claim 2, wherein the vegetable-based wax comprises non-hydrogenated vegetable lipid.

9. The candle composition of claim 8, wherein 55% to 99% by mass of the composition is fatty alcohol and the remainder is non-hydrogenated vegetable lipid.

10. The candle composition of claim 8, wherein 60% to 100% by mass of the composition is fatty alcohol and the remainder is non-hydrogenated vegetable lipid.

11. The candle composition of claim 10, wherein the non-hydrogenated vegetable lipid is selected from the group consisting of soybean oil, sunflower oil, safflower oil, grape seed oil, corn oil, palm oil, olive oil, cotton seed oil, canola oil, coconut oil, jojoba oil and combinations thereof.

12. The candle composition of claim 8, wherein the vegetable-based wax is in solid or semi-solid form at ambient temperature.

13. The candle composition of claim 12, wherein the ambient temperature is from about 18 to about 28° C.

14. The candle composition of claim 6, wherein the fatty acid is selected from the group consisting of lauric acid, myristic acid, palmitic acid, stearic acid, oleic acid, linoleic acid, and any combinations thereof.

15. The candle composition of claim 2, further comprising a fragrance.

16. The candle composition of claim 2, the composition further comprising colorants, antioxidants and/or UV inhibitors.

17. The candle composition of claim 2, wherein the composition comprises at least one wick.

18. The candle composition of claim 17, wherein the composition is within a container.

19. The candle composition of claim 17, wherein the composition is in the shape of a free-standing pillar.

20. A process for making a candle composition comprising
mixing together a fatty alcohol and a vegetable-based wax, heating the mixture to a temperature of 70-80° C., pouring into a container or mould, and cooling said mixture.
